(19) United States
(12) Patent Application Publication
(10) Pub. No.: US 2022/0323801 A1
(43) Pub. Date: Oct. 13, 2022

(54) FIRE SUPPRESSION DEVICE

(71) Applicant: OSMOSE UTILITIES SERVICES, INC., Peachtree City, GA (US)

(72) Inventors: Douglas Herdman, Peachtree City, GA (US); Robert Batchelor, Senoia, GA (US)

(21) Appl. No.: 17/712,851

(22) Filed: Apr. 4, 2022

Related U.S. Application Data
(60) Provisional application No. 63/171,941, filed on Apr. 7, 2021.

(51) Int. Cl. A62C 2/06

(52) U.S. Cl. CPC A62C 2/065

(57) ABSTRACT

The disclosed technology includes a fire suppression device including a non-conductive support layer and an intumescent coating. The non-conductive support layer can include a plurality of non-conductive strands arranged to form a plurality of apertures. The intumescent coating can be disposed on at least a portion of the plurality of non-conductive strands. The intumescent coating can be configured to expand to at least partially close a portion of the plurality of apertures upon the intumescent coating being heated to a temperature greater than or equal to a threshold temperature.

### CROSS REFERENCE TO RELATED APPLICATIONS

This application claims the benefit of U.S. Provisional Application Ser. No. 63/171,941 filed 7 Apr. 2021, which is hereby incorporated by reference in its entirety.

### TECHNICAL FIELD

The disclosed technology relates to a device for protecting a structure from tire and/or extreme heat damage. More particularly, the disclosed technology relates to a fire suppression device including a mesh-like support layer having an intumescent coating.

### BACKGROUND

In recent years, the destruction caused by wildfires has become increasingly more severe, and such fires have occurred with greater frequency. To combat the damage caused by these natural disasters, devices, systems, and methods are needed to provide protection from the intense flames of these fires, particularly with respect to wooden and/or steel structures (e.g., utility poles) that can be particularly vulnerable to wildfires. Grass, shrubs, and other vegetation surrounding the base of such structures can rapidly ignite, creating temperatures in excess of 1500° F. and causing the structures to potentially burst into flame. Because of the high costs of these structures, it can be critical to protect such structures from damage caused by fire and/or extreme thermal events.

Traditional attempts to prevent fire damage to these structures can include the use of fire-retardant coatings and/or formulations that can be sprayed or brushed directly onto a utility pole or other structure. Further, some traditional devices used to prevent tire damage can include a metal wire mesh having a fire-retardant coating. Such devices can be applied to utility poles or other structures to protect the structures in the event of a fire. However, these devices can have several disadvantages. For example, the metal wire mesh can be conductive, thereby creating a risk of potentially intensifying a fire. During a tire, the metal wire mesh can easily and quickly heat beyond an activation temperature of the tire-retardant coating applied to the metal wire mesh. In such instance, the fire-retardant coating can degrade leaving an exposed metal wire mesh. Such exposed metal wire mesh can be unable to prevent future damage from subsequent fires due to the lack of the fire-retardant coating. Additionally, such exposed metal wire mesh can be susceptible to corrosion and can reduce the amount of protection from contact with electrically energized risers or ground wires carrying potentially leaking current down the utility pole or other structure, thus creating an electrical shock hazard to utility workers and other individuals or animals that might come into contact with the exposed metal wire mesh.

Further, a metal wire mesh can corrode easily when exposed to outdoor weather conditions and have limited flexibility and formability. Lack of flexibility and formability can cause the device to be ill-suited for application to utility poles. For example, it can be difficult to sufficiently conform such device having a metal wire mesh to the shape and/or contours of a utility pole or other structure. Similarly, due to the rigid nature of a metal wire mesh, when the device is applied to a utility pole or other structure, gaps and/or raceways can be created. Such gaps and/or raceways can allow for the flow of hot air and gases during thermal or fire events resulting in a “chimney-effect” that can undesirably promote combustion and rapid flame spread. Further, devices including a metal wire mesh can be heavy, making it costly and difficult to transport to remote field locations.

Moreover, some traditional devices include a mesh structure that can be fragile, and thus, must be affixed to a substrate in order to sufficiently protect a structure from fire damage. A fragile mesh structure can be susceptible to structural degradation when draped about a substrate and/or when a fire-retardant coating is applied to the mesh structure. When such mesh structure is not self-supporting, the applications in which such devices can be used can be limited.

Lastly, some existing devices can be difficult to apply to utility poles or other structures due to lack of sufficient adhesion. For example, some existing devices can be difficult to apply to wood structures. Additionally, some existing devices can be difficult to remove from the structure, thereby preventing relatively easy access to the structure for inspection and treatment of the structure and/or maintenance of the device.

### SUMMARY

The above needs and others can be addressed by some implementations of the disclosed technology. The disclosed technology relates to a fire suppression device for protecting a structure from fire and/or thermal damage. The disclosed technology can include a non-conductive support layer including a plurality of non-conductive strands arranged to form a plurality of apertures and an intumescent coating disposed on at least a portion of the plurality of non-conductive strands. The intumescent coating can be configured to expand to at least partially close a portion of the plurality of apertures upon the intumescent coating being heated to a temperature greater than or equal to a threshold temperature.

The plurality of non-conductive strands can comprise basalt fiber.

The plurality of non-conductive strands can comprise at least one of carbon fiber, glass fiber, aramid, fiberglass, and quartz fiber.

The plurality of non-conductive strands can comprise a first non-conductive composition and a second non-conductive composition, the first non-conductive composition being different than the second non-conductive composition.

Each aperture of the plurality of apertures can have a predetermined height and a predetermined width, the predetermined height being between approximately 3.25 mm and approximately 4.75 mm and the predetermined width being between approximately 3.25 mm and approximately 4.75 mm.

A predetermined amount of intumescent coating can be disposed on at least a portion of the plurality of non-conductive strands, the predetermined amount being between approximately 0.08 and approximately 0.20 pounds per square foot of the support layer.

The intumescent coating can comprise a temperature-sensitive pigment configured to change color upon the intumescent coating being heated to the temperature greater than or equal to the threshold temperature.

The threshold temperature can be between approximately 280° F. and approximately 300° F.

The intumescent coating can expand to form a char layer of a predetermined thickness, the predetermined thickness being between approximately 10 mm and approximately 30 mm.

The intumescent coating can expand (i) outwardly toward a source of heat: (ii) inwardly away from the source of heat: and (iii) laterally to at least partially close at least a portion of the plurality of apertures.

The disclosed technology can further include a method of manufacturing a tire suppression device comprising providing a plurality of non-conductive strands forming a plurality of apertures and applying an intumescent coating on at least a portion of the plurality of non-conductive strands. The intumescent coating can be configured to expand to at least partially close a portion of the plurality of apertures upon the intumescent coating being heated to a temperature greater than or equal to a threshold temperature.

Providing the plurality of non-conductive strands can comprise weaving the plurality of non-conductive strands together to form a mesh-like configuration.

A predetermined amount of intumescent coating can be applied to at least a portion of the plurality of non-conductive strands, the predetermined amount of intumescent coating being between approximately 0.08 pounds per square foot to approximately 0.20 pounds per square foot.

A predetermined amount of intumescent coating can be applied to at least a portion of the plurality of non-conductive strands, the predetermined amount of intumescent coating being based at least in part on an estimated magnitude of fires expected to occur at a location in which the fire suppression device is used.

The method can further comprise curing the intumescent coating applied to at least the portion of the plurality of non-conductive strands at a temperature below a boiling point of the intumescent coating.

The disclosed technology can further include a fire suppression system comprising a structure and a fire suppression device affixed to at least a portion of the structure. The fire suppression device can comprise a non-conductive support layer including a plurality of non-conductive strands arranged to form a plurality of apertures and an intumescent coating disposed on at least a portion of the plurality of non-conductive strands. The intumescent coating can be configured to expand to at least partially close a portion of the plurality of apertures upon the intumescent coating being heated to a temperature greater than or equal to a threshold temperature.

The structure can be a wooden utility pole.

The fire suppression device can be wrapped around the structure to conform to the shape of the structure.

Each aperture of the plurality of apertures can be sized to allow for water moisture to permeate into the structure and out of the structure.

The intumescent coating can expand (i) outwardly away from the structure: (ii) inwardly toward the structure: and (iii) laterally to at least partially close at least a portion of the plurality of apertures.

### BRIEF DESCRIPTION OF THE FIGURES

Reference will now be made to the accompanying figures, which are not necessarily drawn to scale. The figures are not intended to limit the scope of the disclosed technology, but, instead, are intended to provide depictions of specific, non-limiting characteristics and/or features of the devices, systems, and methods described herein.

FIG. 1A depicts a top view of an example tire suppression device, in accordance with the disclosed technology.

FIG. 1B illustrates a zoomed-in view of a portion of the fire suppression device of FIG. 1A, in accordance with the disclosed technology.

FIG. 1C depicts a cross-sectional view of the fire suppression device of FIG. 1A, in accordance with the disclosed technology.

FIG. 2 illustrates the tire suppression device of FIGS. 1A-1C applied to a structure, in accordance with the disclosed technology.

### DETAILED DESCRIPTION

The disclosed technology includes devices, systems, and methods for protecting structures from fire damage. The disclosed technology includes a fire suppression device including a support layer having an intumescent coating. The support layer can include a plurality of strands arranged to form a plurality of apertures such that the support layer has a mesh-like configuration. The plurality of strands can be made from a non-conductive material (e.g., basalt fiber). The intumescent coating can be applied to at least a portion of the plurality of strands such that the intumescent coating can impregnate at least a portion of the support layer. The fire suppression device can be applied to various structures (e.g., utility and/or communication poles) to mitigate and/or prevent fire damage to such structures. When the fire suppression device is exposed to high temperature (e.g., a fire), the temperature of the intumescent coating can increase to a temperature greater than or equal to a threshold temperature, thereby causing the intumescent coating to be activated. Upon activation, the intumescent coating can expand and/or swell to form a char layer. Such expansion and swelling of the intumescent coating can at least partially close the apertures of the support layer, thereby preventing a flame or hot gases produced from the flame from penetrating and damaging the underlying structure.

Aspects of the disclosed technology will be described more fully hereinafter with reference to the accompanying drawings. This disclosed technology can, however, be embodied in many different forms and should not be construed as limited to the examples set forth therein.

In the following description, numerous specific details are set forth. However, it is to be understood that various examples of the disclosed technology can be practiced without these specific details. In other instances, well-known methods, structures, and techniques have not been shown in detail in order to not obscure an understanding of this description. References to “one embodiment,” “an embodiment,” “example embodiment,” “some embodiments,” “certain embodiments,” “various embodiments,” “one example,” “an example,” “some examples,” “certain examples,” “various examples,” etc., indicate that the example(s) of the disclosed technology so described can include a particular feature, structure, or characteristic, but not every implementation of the disclosed technology necessarily includes the particular feature, structure, or characteristic.

Unless otherwise noted, the terms used herein are to be understood according to conventional usage by those of ordinary skill in the relevant art. In addition to any definitions of terms provided below, it is to be understood that as used in the specification and in the claims. “a” or “an” can mean one or more, depending upon the context in which it is used. Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Unless otherwise specified, any range of values provided herein is inclusive of its endpoints. For example, the phrases “between 4 and 6” and “from 4 to 6” both indicate a range of values that includes 4, 6, and all values therebetween.

Also, in describing various examples of the disclosed technology, terminology will be resorted to for the sake of clarity. It is intended that each term contemplates its broadest meaning as understood by those skilled in the art and includes all technical equivalents that operate in a similar manner to accomplish a similar purpose.

The materials described hereinafter as making up the various examples described herein are intended to be illustrative and not restrictive. Many suitable materials that would perform the same or a similar function as the materials described herein are intended to be embraced within the scope of the disclosure. Such other materials not described herein can include, but are not limited to, materials that are developed alter the time of the development of the disclosed technology, for example.

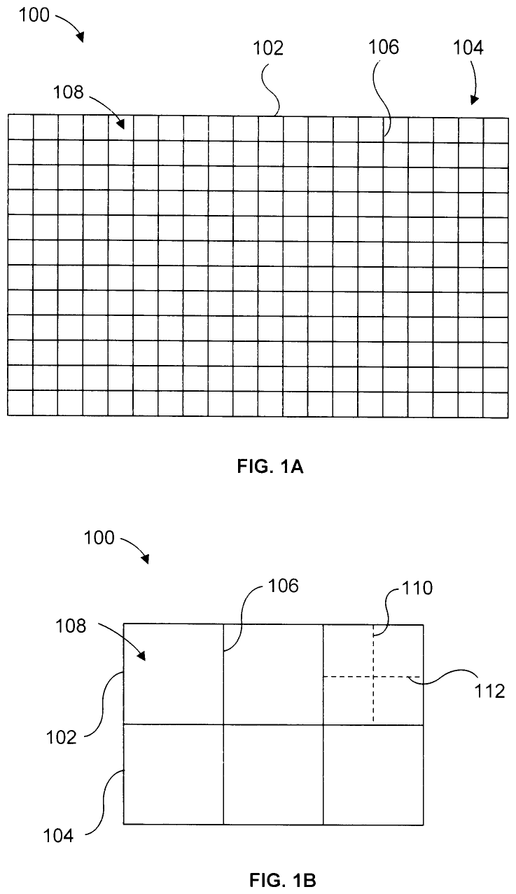

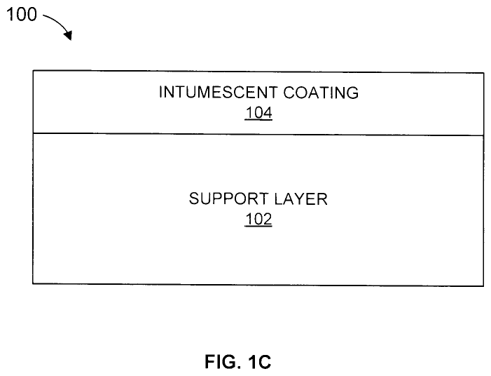

Referring now to the drawings. FIGS. 1A-IC illustrate an example fire suppression device 100. The first suppression device 100 can include a support layer 102 and an intumescent coating 104 applied to at least a portion of the support layer 102. The support layer 102 can include a plurality of strands 106 configured to form a mesh-like pattern. For example, strands 106 can be woven together by overlapping and/or underlapping strands 106 to form such mesh-like pattern. In such configuration, the plurality of strands 106 can create a plurality of apertures 108.

The plurality of strands 106 of the support layer 102 can be made of a non-conductive composition. By way of example, the plurality of strands 106 can be made of basalt fiber. Basalt fiber can provide a variety of advantages. For example, basalt fiber can be substantially environmentally friendly and produce limited pollution. Basalt fiber can be a fibrous material made from basaltic rock. When the plurality of strands 106 are substantially made of basalt fiber, the support layer 102 can exhibit preferable mechanical properties. For example, as compared to other non-conductive and/or conductive materials, when the plurality of strands 106 are made substantially of basalt fiber, the support layer 102 can have a high tensile strength and modulus of elasticity, high corrosion resistance and chemical stability, high electrical insulation, and high thermal stability. Additionally, when the plurality of strands 106 are made substantially of basalt fiber, the support layer 102 can be substantially porous and have high temperature resistance and permanent flame retardancy as compared to other non-conductive and/or conductive materials. Accordingly, the fire suppression device 100 can be used in extreme temperature environments for extended periods of time. Further, when the plurality of strands 106 are made substantially of basalt fiber, the support layer 102 can be substantially resistant to acid and alkali and to ultraviolet (UV) degradation as compared to other non-conductive and/or conductive materials.

Alternatively or in addition, the plurality of strands 106 can be made of other non-conductive materials, including carbon fiber, glass fiber, aramid, fiberglass. S-glass. E-glass. R-glass, and quartz fiber.

Optionally, all of the strands of the plurality of strands 106 can be made of the same non-conductive material. Alternatively, a portion of the plurality of strands 106 can be made with one non-conductive material while a portion of the plurality of strands 106 can be made with a different non-conductive material.

As illustrated in FIG. 1B, the plurality of strands 106 can be woven together to form a plurality of apertures 108. Each aperture 108 can have any shape. By way of example, each aperture 108 can have a substantially square, rectangular, circular, ovular, or other polygonal shape. Each aperture 108 can have the same shape. Alternatively, at least one aperture 108 can have a different shape.

Each aperture 108 can be configured to have a predetermined height and a predetermined width (or in the instance each aperture 108 is substantially circular, a predetermined diameter). Each aperture 108 can have a height 110 of approximately 4 mm±0.75 mm (e.g., a height 110 of between approximately 3.25 mm and approximately 4.75 mm) and a width 112 of approximately 4 mm±0.75 mm (e.g., a width 112 of between approximately 3.25 mm and approximately 4.75 mm). Each aperture 108 can have an area of between approximately 10.5 mm² to approximately 22.6 mm².

The intumescent coating 104 can include a tire retardant and an aqueous carrier. Optionally, the intumescent coating 104 can be water based. Alternatively or in addition, the intumescent coating 104 can be viscous.

The intumescent coating 104 can be applied to the plurality of strands 106 of the support layer 102 such that the intumescent coating 104 can impregnate at least a portion of the support layer 102. Optionally, the intumescent coating 104 can be applied to one face or a portion of one face of the support layer 102. Optionally, the intumescent coating 104 can be applied to each face or a portion of each face of the support layer 102. Optionally, the intumescent coating 104 can be applied to the entirety of the support layer 102 (e.g., the surface area of all of the plurality of strands 106 of the support layer 102). Alternatively, the intumescent coating 104 can be applied to a portion of the support layer 102 (e.g., a portion of the surface area of the plurality of the strands 106 and/or all of the surface area of only a portion of the plurality of strands 106).

A predetermined amount of intumescent coating 104 can be applied to the support layer 102. The predetermined amount of intumescent coating 104 can be equal to an amount that can be effective to render the tire suppression device 100 resistant to tire. The predetermined amount of intumescent coating 104 can be between approximately 0.08 pounds per square foot to approximately 0.20 pounds per square foot. In one example, the predetermined amount of intumescent coating 104 can be approximately 0.14 pounds per square foot. In one example, the predetermined amount of intumescent coating 104 can be based at least in part on the predicted magnitude of fires expected to occur at the location in which the fire suppression device 100 is being used. For example, the predetermined amount of intumescent coating 104 can be approximately 0.08 pounds per square foot for relatively small fires and approximately 0.20 pounds per square foot for relatively large tires.

The intumescent coating 104 can be applied to the support layer 102 using a variety of manufacturing techniques. For example, the intumescent coating 104 can be applied to the support layer 102 via spraying, rolling, dipping, brushing, or various combinations of one or more of these methods. The viscosity and manufacturing process can be varied in order to achieve a target thickness. Optionally, a plurality of layers of intumescent coating 104 can be applied to the support layer 102.

Optionally, after applying the intumescent coating 104 to the support layer 102, the intumescent coating 104 can be cured. The intumescent coating 104 can be cured at a temperature below the boiling point of the intumescent coating 104 (e.g., 212° F.). In one example, the intumescent coating 104 can be cured at a temperature of between approximately 110° F. and 120° F. A heat source can be used to cure the intumescent coating 104. For example, an oven, a heat lamp, an infrared lamp, or any other heat source can be used to cure the intumescent coating 104. Alternatively or in addition to, forced air can be used to cure the intumescent coating 104. In the instance a plurality of layers of intumescent coating 104 are applied to the support layer 102, each layer of intumescent coating 104 can be cured after being applied. Alternatively, the intumescent coating 104 can be cured after all layers have been applied or after a predetermined number of layers have been applied to the support layer 102.

Optionally, the tire suppression device 100 can further include a pigment. Optionally, the pigment can be incorporated into the intumescent coating 104. Alternatively or in addition to, the pigment can be applied to the support layer 102 before and/or after the intumescent coating 104 is applied. The pigment can render the fire suppression device 100 any color (e.g., brown, green, black, or any other shade of color), such that the fire suppression device 100 can be visible to individuals, including utility workers applying and/or inspecting the tire suppression device 100. Optionally, the pigment can be temperature sensitive. For example, the pigment can be configured to change colors when exposed to a temperature greater than or equal to a threshold temperature. Accordingly, when the fire suppression device 100 is exposed to tire and/or any other thermal event, the fire suppression device 100, and thereby the pigment, can become heated to a temperature that is greater than or equal to a threshold temperature. As a result, the pigment can cause the fire suppression device 100 to change color. For example, the fire suppression device 100 can initially be a gray color. Upon exposure to tire or other thermal event that causes the pigment of the fire suppression device 100 to reach or exceed the threshold temperature, the pigment can change to a darker, charred color.

The fire suppression device 100 can withstand deterioration due to prolonged exposure to harsh environmental and weather conditions, including high temperature, pollution, humidity, strong sunlight, wind moisture, snow, acidic environment, and other extreme environmental conditions. The fire suppression device 100 can further withstand excessive water adsorption and subsequent chemical leaching that can occur during repeated rain events or in the event of submersion in standing water (e.g., flood-like conditions). Additionally, the fire suppression device 100 can be lightweight, and thus, can be easily transported to field locations and applied to various structures.

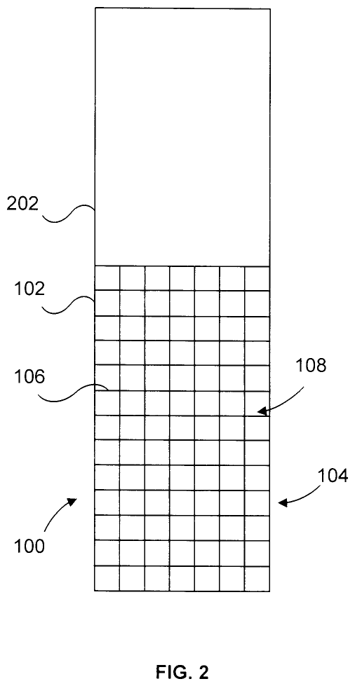

FIG. 2 illustrates the fire suppression device 100 applied to a structure 202 such that at least a portion of the structure 202 can be substantially protected from fire damage. The structure 202 can be a flammable structure, including a wooden pole. Optionally, the structure 202 can be a non-flammable structure made of metal and/or composite materials. The structure 202 can be a utility and/or communications pole.

The support layer 102 can be substantially flexible. Additionally, the intumescent coating 104 can be substantially elastic and capable of flexing. Accordingly, the fire suppression device 100 can be tightly molded to the structure 202, as the fire suppression device 100 can conform to the shape and/or contours of the structure 202. For example, fire suppression device 100 can conform around one or more attachments, conduits, and/or moldings (e.g., riser wires) of the structure 202. Because the fire suppression device 100 can conform to the shape and/or contours of any structure 202, the fire suppression device 100 can be applied to a cylindrical structure (e.g., a utility pole) and/or any planar or curved structure. Alternatively or in addition, the fire suppression device 100 can be applied to any tree, wall, roof, or other similar structure or surface.

By tightly applying and/or molding the fire suppression device 100 to the structure 202, air-gaps and/or raceways can be minimized and/or prevented. Such air-gaps and/or raceways can allow hot air and gases to flow upwards along the structure 202 during fires and/or other thermal events, thereby creating an undesirable “chimney-effect” that can promote combustion and rapid flame spread.

The tire suppression device 100 can be applied to the structure 202, as illustrated in FIG. 2. The tire suppression device 100 can be applied to any portion of the structure 202 (e.g., 10%, 20%, 50%, 75%, or any other percentage of the structure 202). Optionally, the fire suppression device 100 can be applied to a portion of the structure 202 that is proximate the ground, and thereby more susceptible to tire damage (e.g., the tire suppression device 100 can be applied to the bottom 20%, 25%, or 50% of the structure 202). Optionally, the fire suppression device 100 can be applied to approximately a middle of the structure 202. Optionally, the fire suppression device 100 can be applied to approximately a top portion of the structure 202. Optionally, the fire suppression device 100 can be applied to substantially all of the structure 202.

Optionally, the fire suppression device 100 can be secured to the structure 202 using one or more attachment means (e.g., mechanical fasteners such as nails, staples, spikes, tacks, screws, and the like and/or adhesives).

The tire suppression device 100 can be sufficiently porous such that the fire suppression device 100 is permeable to water vapor. Accordingly, water vapor can pass through the fire suppression device 100, thereby allowing moisture to enter and exit the structure 202. By allowing moisture to freely enter and exit the structure 202 as needed, premature chemical migration or degradation that can lead to decay or insect attack of the structure 202 can be minimized and/or prevented.

As discussed above with reference to FIG. 1B, the support layer 102 can include a plurality of strands 106 arranged to form a plurality of apertures 108. Such apertures 108 can be sized to allow the structure 202 to be visible to individuals, including utility and/or field workers. For example, structures 202 having the tire suppression device 100 applied to the outer surface area of the structure 202 can still be examined and/or inspected by individuals. Accordingly, utility pole identification information, inspection tags, pole attachments such as riser lines and other hardware attachments, and previously drilled inspection holes and remedial treatment application holes can remain visible, and thus, can be reused for subsequent inspection and treatment cycles. Additionally, the apertures 108 can be sized to allow for sufficient moisture transfer from the structure 202 to the atmosphere.

During a fire and/or other thermal event, the temperature of the intumescent coating 104 can increase. Upon the temperature of the intumescent coating 104 increasing to a temperature that is above a threshold temperature, the intumescent coating 104 can be activated. The threshold temperature can correspond to a temperature indicative of a fire and/or other thermal event. For example, the threshold temperature can be between approximately 280° F. and approximately 300° F. In one example, the intumescent coating 104 can scorch at approximately 280° F. and begin to intumescence at approximately 300° F. Upon activation of the intumescent coating 104, the intumescent coating 104 can expand and/or swell to form a char layer of a predetermined thickness. For example, the intumescent coating 104 can expand and/or swell to form a char layer having a thickness of between approximately 10 mm and approximately 30 mm. In one example, the intumescent coating 104 can expand and/or swell to form a char layer having a thickness of approximately 15 mm. The intumescent coating 104 can expand three-dimensionally. For example, the intumescent coating 104 can expand outwardly toward the heat and/or flame source, laterally toward the apertures 108 of the support layer 102 to prevent heat transfer to the structure 202, and/or inwardly to tightly form around the structure 202 to substantially close any gaps or spaces that could allow air to enter and facilitate undesired combustion. Such expansion of the intumescent coating 104 can at least partially close at least a portion of the apertures 108 of the support layer 102. Optionally, the expansion of the intumescent coating 104 can entirely close at least a portion of the apertures 108 and/or all of the apertures 108 of the support layer 102. Such partial and/or complete closing of the apertures 108 can protect the underlying structure 202 from substantial fire damage and strength degradation by suppressing flame and heat transfer to the structure 202.

Optionally, the tire suppression device 100 can be gaffable once applied to the structure 202. The fire suppression device 100 can be punctured by gaff spikes, gaff hooks, or other similar climbing equipment. Thereby, individuals, including utility workers, can use such climbing equipment to ascend and descend, the structure 202. For example, a utility worker wearing gaff spikes and/or gaff hooks can ascend a structure 202 to reach the portion of the structure 202 in which the fire suppression device 100 is applied.

Optionally, the tire suppression device 100 can be punctured once applied to the structure 202. The fire suppression device 100 can be punctured using one or more knives, bores, drills, or other mechanical devices capable of puncturing the fire suppression device 100. Upon puncturing the fire suppression device 100, individuals, including utility workers, can easily apply treatments (e.g., preservatives and/or fumigants) to the structure 202 or inspect the structure 202 without removing the fire suppression device 100. Optionally, a utility worker can cut away a portion of the tire suppression device from a region of the structure 202 where a fumigant plug had previously been applied to the structure 202 in order to remove the previously applied fumigant plug and apply a new fumigant plug.

Optionally, the tire suppression device 100 can be repaired after being applied to the structure 202 and subsequently damaged. The tire suppression device 100 can be damaged due to a fire and/or other thermal events and additionally due to a variety of environmental conditions, including wind and precipitation. Animals, including woodpeckers, can also cause damage to the fire suppression device 100. Further, the tire suppression device 100 can be damaged (e.g., punctured, torn, ripped, and the like) by utility workers when inspecting the structure 202 and/or applying treatment to the structure 202. The fire suppression device 100 can be repaired by cutting away the damaged region of the tire suppression device 100 and subsequently patching such region with a small portion of support layer 102 that has been coated with the intumescent coating 104. Alternatively or in addition, repairing the fire suppression device 100 can include cutting away the damaged region of the fire suppression device 100, applying additional layers of the intumescent coating 104 to that region of the fire suppression device 100, and curing the newly added layers of the intumescent coating 104.

Optionally, the fire suppression dev ice 100 can be removed from the structure 202. For example, any attachment means (e.g., mechanical fasteners) used to secure the tire suppression device 100 to the structure 202 can be first removed. Subsequently, the fire suppression device 100 can be easily removed from the structure 202 by unwrapping the tire suppression device 100, pulling the fire suppression device laterally away from the structure, or the like.

While certain examples of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

EXAMPLE 1 and EXAMPLE 2 are two examples of a fire suppression device 100 and the characteristics associated therewith.

EXAMPLE 1. A waterborne intumescent coating 104 was applied by spraying onto a non-conductive basalt fiber mesh support layer 102 consisting of apertures 108 having a height 110 and a width 112 of 4 mm at a rate of 0.10 pounds per square foot. Minimal windowing or closure of the apertures 108 was noted. Upon drying, or curing, the water-based intumescent coating 104 showed good adhesion properties to the non-conductive basalt support layer 102 with no evidence of peeling, cracking, or flaking. Further, the constructed fire suppression device 100 showed good drapability and flexibility such that the fire suppression device 100 could be efficiently applied to a structure 202 (e.g., an in-service wood utility structure) and could conform to the irregular surfaces of the structure 202 and to all conceivable attachments and appendages such as risers and ground wire attachments.

EXAMPLE 2. A waterborne intumescent coating 104 was applied by brushing onto a non-conductive basalt fiber mesh support layer 102 consisting of apertures 108 having a height 110 and a width 112 of 4.75 mm at a rate of 0.14 pounds per square foot. Minimal windowing or closure of the apertures 108 was noted. Upon drying, or curing, the water-based intumescent coating 104 showed good adhesion properties to the non-conductive basalt support layer 102 with no evidence of peeling, cracking, or flaking. Further, the constructed fire suppression device 100 showed good drapability and flexibility such that the tire suppression device 100 could be efficiently applied to a structure 202 (e.g., an in-service wood utility structure) and could conform to the irregular surfaces of the pole and to all conceivable attachments and appendages such as risers and ground wire attachments.

EXAMPLE 3 and EXAMPLE 4 are two examples of the fire suppression devices 100 as described in EXAMPLE 1 and EXAMPLE 2, respectively, being applied to a structure 202.

EXAMPLE 3. The fire suppression device 100 derived in EXAMPLE 1 was applied to a structure 202 (e.g., a full-sized utility pole section) that was commercially treated with pentachlorophenol. The fire suppression device 100 was applied to the structure 202 from 3 inches below ground to 40 inches above ground as a single layer using staples. To simulate the conditions of a wildfire, twenty-five pounds of dry wheat straw was stacked around the structure 202 for use as a fuel source in direct contact with the tire suppression device 100. Straw was confined to the structure 202 within an 18-inch radius using wire fencing. Fuel height was approximately 24-inches. The fuel was then ignited and allow to burn until combustion was complete. The fuel source was consumed in 8 minutes and a maximum temperature of 1600° F. was recorded on the surface of the structure 202. The intumescent coating 104 expanded laterally to completely close all apertures 108 of the support layer 102 and expanded outward toward the heat source from 10-15 mm. The surface of the structure 202 darkened slightly but did not experience charring or resulting strength loss. The tire suppression der ice 100 completely protected the wood pole section of the structure 202 from damage by heat and combustion.

EXAMPLE 4. The tire suppression device 100 derived in EXAMPLE 2 was applied to a structure 202 (e.g., a full-sized utility pole section) that was commercially treated with pentachlorophenol. The tire suppression device 100 was applied to the structure 202 from 3 inches below ground to 40 inches above ground as a single layer using staples. To simulate the conditions of a wildfire, twenty-five pounds of dry wheat straw was stacked around the structure 202 for use as a fuel source in direct contact with the tire suppression device 100. Straw was confined to the structure 202 within an 18-inch radius using wire fencing. Fuel height was approximately 24-inches. The fuel was then ignited and allow to burn until combustion was complete. The fuel source was consumed in 9.5 minutes and a maximum temperature of 1537° F. was recorded on the surface of the structure 202. Maximum flame height exceeded 6 feet during consumption of the fuel source. The intumescent coating 104 expanded laterally to completely close all apertures 108 of the support layer 102 and expanded outward toward the heat source from 15-30 mm. The surface of the structure 202 darkened slightly near the groundline but did not experience charring or resulting strength loss. The fire suppression device 100 completely protected the wood pole section from damage by heat and combustion.

What is claimed is:

1. A fire suppression device comprising:
a non-conductive support layer including a plurality of non-conductive strands arranged to form a plurality of apertures: and
an intumescent coating disposed on at least a portion of the plurality of non-conductive strands, the intumescent coating configured to expand to at least partially close a portion of the plurality of apertures upon the intumescent coating being heated to a temperature greater than or equal to a threshold temperature.

2. The fire suppression device of claim 1, wherein the plurality of non-conductive strands comprises basalt fiber.

3. The fire suppression device of claim 1, wherein the plurality of non-conductive strands comprises at least one of carbon fiber, glass fiber, aramid, fiberglass, and quartz fiber.

4. The fire suppression device of claim 1, wherein the plurality of non-conductive strands comprises a first non-conductive composition and a second non-conductive composition, the first non-conductive composition being different than the second non-conductive composition.

5. The fire suppression device of claim 1, wherein each aperture of the plurality of apertures has a predetermined height and a predetermined width, the predetermined height being between approximately 3.25 mm and approximately 4.75 mm and the predetermined width being between approximately 3.25 mm and approximately 4.75 mm.

6. The fire suppression device of claim 1, wherein a predetermined amount of intumescent coating is disposed on at least a portion of the plurality of non-conductive strands, the predetermined amount being between approximately 0.08 and approximately 0.20 pounds per square foot of the support layer.

7. The fire suppression device of claim 1, wherein the intumescent coating comprises a temperature-sensitive pigment configured to change color upon the intumescent coating being heated to the temperature greater than or equal to the threshold temperature.

8. The fire suppression device of claim 1, wherein the threshold temperature is between approximately 280° F. and approximately 300° F.

9. The fire suppression device of claim 1, wherein the intumescent coating expands to form a char layer of a predetermined thickness, the predetermined thickness being between approximately 10 mm and approximately 30 mm.

10. The fire suppression device of claim 1, wherein the intumescent coating expands (i) outwardly toward a source of heat: (ii) inwardly away from the source of heat: and (iii) laterally to at least partially close at least a portion of the plurality of apertures.

11. A method of manufacturing a fire suppression device comprising:
providing a plurality of non-conductive strands forming a plurality of apertures; and
applying an intumescent coating on at least a portion of the plurality of non-conductive strands, the intumescent coating configured to expand to at least partially close a portion of the plurality of apertures upon the intumescent coating being heated to a temperature greater than or equal to a threshold temperature.

12. The method of claim 11, wherein providing the plurality of non-conductive strands comprises weaving the plurality of non-conductive strands together to form a mesh-like configuration.

13. The method of claim 11, wherein a predetermined amount of intumescent coating is applied to at least a portion of the plurality of non-conductive strands, the predetermined amount of intumescent coating being between approximately 0.08 pounds per square foot to approximately 0.20 pounds per square foot.

14. The method of claim 11, wherein a predetermined amount of intumescent coating is applied to at least a portion of the plurality of non-conductive strands, the predetermined amount of intumescent coating being based at least in part on an estimated magnitude of fires expected to occur at a location in which the fire suppression device is used.

15. The method of claim 11, further comprising curing the intumescent coating applied to at least the portion of the plurality of non-conductive strands at a temperature below a boiling point of the intumescent coating.

16. A fire suppression system comprising:
a structure; and
a fire suppression device affixed to at least a portion of the structure, the tire suppression device comprising:
a non-conductive support layer including a plurality of non-conductive strands arranged to form a plurality of apertures; and
an intumescent coating disposed on at least a portion of the plurality of non-conductive strands, the intumescent coating configured to expand to at least partially close a portion of the plurality of apertures upon the intumescent coating being heated to a temperature greater than or equal to a threshold temperature.

17. The tire suppression system of claim 16, wherein the structure is a wooden utility pole.

18. The fire suppression system of claim 16, wherein the tire suppression device is wrapped around the structure to conform to the shape of the structure.

19. The tire suppression system of claim 16, wherein each aperture of the plurality of apertures is sized to allow for water moisture to permeate into the structure and out of the structure.

20. The fire suppression system of claim 16, wherein the intumescent coating expands (i) outwardly away from the structure: (ii) inwardly toward the structure: and (iii) laterally to at least partially close at least a portion of the plurality of apertures.
